(19) United States
(12) Patent Application Publication
(10) Pub. No.: US 2026/0198513 A1
(43) Pub. Date: Jul. 16, 2026

(54) CHOCOLATE PRODUCT

(71) Applicant: Kraft Foods Schweiz Holding GmbH, Zug (CH)

(72) Inventors: Indraneil Mukherjee, East Hanover, NJ (US); Clive Norton, East Hanover, NJ (US); Lawrence Harris, East Hanover, NJ (US)

(21) Appl. No.: 19/135,026

(22) PCT Filed: Dec. 20, 2023
(86) PCT No.: PCT/EP2023/087002

§ 371 Date: Jun. 2, 2025

Related U.S. Application Data
(60) Provisional application No. 63/434,418, filed on Dec. 21, 2022.

(51) Int. Cl. A23G 1/46; A23G 1/30; A23G 1/38; A23G 1/40

(52) U.S. Cl. CPC A23G 1/46; A23G 1/305; A23G 1/38; A23G 1/40

(57) ABSTRACT

The present invention relates to a chocolate product comprising at least one cocoa ingredient, at least one dairy ingredient and at least one softening ingredient, wherein at least one of the following conditions is satisfied: a) the dairy ingredient is present in at least 35.4 g per 100 g of the chocolate product and the cocoa ingredient is present in at least 47.2 g per 100 g of the chocolate product and preferably the total combined amount of the dairy ingredient and cocoa ingredient is no more than 95 g per 100 g of the chocolate product; or b) the dairy ingredient is present in at least 35.4 g per 100 g of the chocolate product and the total combined amount of cocoa ingredient and softening ingredient is at least 47.2 g per 100 g of the chocolate product, wherein the softening ingredient is derived from nuts and/or seeds and wherein preferably the total combined amount of the dairy ingredient, softening ingredient and cocoa ingredient is no more than 95 g per 100 g of the chocolate product. The present invention also relates to a method of preparing a chocolate product according to the present invention, the method comprising the step of combining at least one cocoa ingredient, dairy ingredient, and at least one softening agent.

### TECHNICAL FIELD OF THE INVENTION

The present invention relates to chocolate products and packaged chocolate. The invention also relates to methods of preparing such chocolate products.

### BACKGROUND TO THE INVENTION

Many chocolate products on the market are considered energy dense foods; driven largely by sugar and fat-based ingredients necessary for the characteristic structure, taste, color and texture.

There has been significant attention to sugar and higher energy dense foods in recent years and opportunities exist to develop lower sugar and/or energy chocolate products.

Moreover, there is also the need to develop nutritious chocolate products able to provide one or more of the food groups recommended for consumption by the Dietary Guidelines in some territories.

One solution to this problem may be to provide these food groups as additional ingredients in existing formulations. However, the serving size of chocolate products are limited in order not to exceed daily recommended consumption. Typically, the recommended serving size for a chocolate product is 30 g.

Consequently, there exists a problem in providing one or more food groups in a recommended serving size of a chocolate product without compromising texture, taste, color and mouthfeel.

Therefore, it is an aim of the present invention to provide a chocolate product that is able to provide one or more food groups per serving.

It is also an aim of the present invention to provide a chocolate product which provides one or more of the following advantages:
Improved fat bloom resistance;
Improved sugar bloom resistance
Improved heat resistance;
Improved antioxidation properties and/or reduced rancidity;
Have relatively low saturated fat and/or sugar content.
Provide a good mouthfeel.
Provide an authentic chocolate flavor.
Provide a good rigidity, and preferably good mouthfeel.

It is also an aim of embodiments of the invention to overcome or mitigate at least one problem of the prior art, whether expressly described herein or not.

### SUMMARY OF THE INVENTION

According to a first aspect of the invention there is provided a chocolate product comprising at least one cocoa ingredient, at least one dairy ingredient and at least one softening ingredient, wherein at least one of the following conditions is satisfied:
a) the dairy ingredient is present in at least 35.4 g per 100 g of the chocolate product and the cocoa ingredient is present in at least 47.2 g per 100 g of the chocolate product and preferably the total combined amount of the dairy ingredient and cocoa ingredient is no more than 95 g per 100 g of the chocolate product; or
b) the dairy ingredient is present in at least 35.4 g per 100 g of the chocolate product and the total combined amount of cocoa ingredient and softening ingredient is at least 47.2 g per 100 g of the chocolate product, wherein the softening ingredient is derived from nuts and/or seeds and wherein preferably the total combined amount of the dairy ingredient, softening ingredient and cocoa ingredient is no more than 95 g per 100 g of the chocolate product.

Such a chocolate product is able to provide a number of nutritious ingredients whilst still providing an authentic chocolate flavor, good mouthfeel, and good rigidity.

The term ‘chocolate’ includes any material that meets a legal definition of chocolate in any jurisdiction. However, the term ‘chocolate’ is not limited to material which meets any legal definition of chocolate, and also includes chocolate substitutes and analogues.

The term ‘cocoa’, as used in any context throughout this specification, is also taken to include the tautologous terminology ‘cacao’.

The at least one cocoa ingredient may be one or more cocoa solids from any part of the cocoa bean or cocoa pod.

The at least one cocoa ingredient may be one or more ingredients selected from the group consisting of cocoa mass, cocoa powder, cocoa pulp, dried cocoa pulp, cocoa husk and cocoa shell.

Preferably, the at least one cocoa ingredient is cocoa mass.

The dairy ingredient may comprise one or more ingredients selected from the group comprising whole milk, skimmed milk, low fat milk, low fat milk powder, skimmed milk powder, whole milk powder, anhydrous milk fat and whey powder.

Preferably, the dairy product is a milk powder selected from the group comprising skimmed milk powder, whole milk powder, low fat milk powder and whey powder.

Preferably, the dairy ingredient is low fat milk powder.

The softening ingredient may be a paste, oil or butter.

Preferably, the softening ingredient is a butter.

The softening ingredient may be derived from nuts and/or seeds.

The softening ingredient may be derived from nuts and/or seeds selected from the group comprising almonds, peanuts, macadamia nuts, hazelnuts, coconut, pecans, palm, walnuts, pistachios, cashews, and Brazil nuts, sunflower seeds, poppy seeds, pumpkin seeds, chia seeds, canola seeds, coffee beans, and cocoa beans.

The term “nuts” as used herein includes true nuts, ground nuts, tree nuts, seeds considered nuts in the culinary sense, and legumes. Examples of legumes which may fall within the term “nuts” include peanut or carob.

Preferably, the softening ingredient is derived from nuts and/or seeds selected from the group comprising cocoa beans, palm nuts, hazelnuts, walnuts, peanuts, canola seeds and sunflower seeds.

More preferably, the softening ingredient is a butter derived from nuts and/or seeds selected from the group comprising cocoa beans, palm nuts, canola seeds, hazelnuts, walnuts, peanuts and sunflower seeds.

In some embodiments, the dairy ingredient may be present in an amount of at least 35.4 g, 35.5, 35.6, 35.7, 35.8, 35.9, 35.6, 35.7, 35.7, 35.8, 35.9, 36, 36.1, 36.2, 36.3, 36.4, 36.5, 36.6, 36.7, 36.8, 36.9, 37, 37.1, 37.2, 37.3, 37.4, 37.5, 37.6, 37.7, 37.8, 37.9, 38, 38.1, 38.2, 38.3, 38.4, 38.5, 38.6, 38.7, 38.8, 38.9, 39, 39.1, 39.2, 39.3, 39.4, 39.5, 39.6, 39.7, 39.8, 39.9, 40, 40.1, 40.2, 40.3, 40.4, 40.5, 40.6, 40.7, 40.8, 40.9, 41, 41.1, 41.2, 41.3, 41.4, 41.5, 41.6, 41.7, 41.8, 41.9, 42, 42.1, 42.2, 42.3, 42.4, 42.5, 42.6, 42.7, 42.8, 42.9, 43, 43.1, 43.2, 43.3, 43.4, 43.5, 43.6, 43.7, 43.8, 43.9, 44, 44.1, 44.2, 44.3, 44.4, 44.5, 44.6, 44.7, 44.8, 44.9 or at least 45 g per 100 g of the chocolate product and the cocoa ingredient is present in at least 47.2 g, 47.3, 47.4, 47.5, 47.6, 47.7, 47.8, 47.9, 48, 48.1, 48.2, 48.3, 48.4, 48.5, 48.6, 48.7, 48.8, 48.9, 49, 49.1, 49.2, 49.3, 49.4, 49.5, 49.6, 49.7, 49.8, 49.9, 50, 50.1, 50.2, 50.3, 50.4, 50.5, 50.6, 50.7, 50.8, 50.9, 51, 51.1, 51.2, 51.3, 51.4, 51.5, 51.6, 51.7, 51.8, 51.9, 52, 52.1, 52.2, 52.3, 52.4, 52.5, 52.6, 52.7, 52.8, 52.9, 53, 53.1, 53.2, 53.3, 53.4, 53.5, 53.6, 53.7, 53.8, 53.9, 54, 54.1, 54.2, 54.3, 54.4, 54.5, 54.6, 54.7, 54.8, 54.9, 55, 55.1, 55.2, 55.3, 55.4, 55.5, 55.6, 55.7, 55.8, 55.9, 56, 56.1, 56.2, 56.3, 56.4, 56.5, 56.6, 56.7, 56.8, 56.9, or at least 57 g per 100 g of the chocolate product and the total combined amount of the dairy ingredient and cocoa ingredient is no more than 95 g per 100 g of the chocolate product.

In some embodiments, the dairy ingredient is present in at least 35.4 g, 35.5, 35.6, 35.7, 35.8, 35.9, 35.6, 35.7, 35.7, 35.8, 35.9, 36, 36.1, 36.2, 36.3, 36.4, 36.5, 36.6, 36.7, 36.8, 36.9, 37, 37.1, 37.2, 37.3, 37.4, 37.5, 37.6, 37.7, 37.8, 37.9, 38, 38.1, 38.2, 38.3, 38.4, 38.5, 38.6, 38.7, 38.8, 38.9, 39, 39.1, 39.2, 39.3, 39.4, 39.5, 39.6, 39.7, 39.8, 39.9, 40, 40.1, 40.2, 40.3, 40.4, 40.5, 40.6, 40.7, 40.8, 40.9, 41, 41.1, 41.2, 41.3, 41.4, 41.5, 41.6, 41.7, 41.8, 41.9, 42, 42.1, 42.2, 42.3, 42.4, 42.5, 42.6, 42.7, 42.8, 42.9, 43, 43.1, 43.2, 43.3, 43.4, 43.5, 43.6, 43.7, 43.8, 43.9, 44, 44.1, 44.2, 44.3, 44.4, 44.5, 44.6, 44.7, 44.8, 44.9 or at least 45 g per 100 g of the chocolate product and the total combined amount of cocoa ingredient and softening ingredient is at least 47.2 g, 47.3, 47.4, 47.5, 47.6, 47.7, 47.8, 47.9, 48, 48.1, 48.2, 48.3, 48.4, 48.5, 48.6, 48.7, 48.8, 48.9, 49, 49.1, 49.2, 49.3, 49.4, 49.5, 49.6, 49.7, 49.8, 49.9, 50, 50.1, 50.2, 50.3, 50.4, 50.5, 50.6, 50.7, 50.8, 50.9, 51, 51.1, 51.2, 51.3, 51.4, 51.5, 51.6, 51.7, 51.8, 51.9, 52, 52.1, 52.2, 52.3, 52.4, 52.5, 52.6, 52.7, 52.8, 52.9, 53, 53.1, 53.2, 53.3, 53.4, 53.5, 53.6, 53.7, 53.8, 53.9, 54, 54.1, 54.2, 54.3, 54.4, 54.5, 54.6, 54.7, 54.8, 54.9, 55, 55.1, 55.2, 55.3, 55.4, 55.5, 55.6, 55.7, 55.8, 55.9, 56, 56.1, 56.2, 56.3, 56.4, 56.5, 56.6, 56.7, 56.8, 56.9, or at least 57 g per 100 g of the chocolate product, wherein the softening ingredient is derived from nuts and/or seeds and wherein the total combined amount of the dairy ingredient, softening ingredient and cocoa ingredient is no more than 95 g per 100 g of the chocolate product.

The chocolate product may contain one or more further ingredients.

The further ingredient may be one or more ingredients selected from the group comprising a sugar, fat, oil, emulsifier, thickener, preservative, water, colors, flavors, sweetener, and sugar replacer, and salt, among others The term “sugar” refers to a monosaccharide or disaccharide with an energy content of >3 kcal/g. Examples of suitable sugars include glucose, fructose, galactose, sucrose, lactose, maltose, and sugar hydrates (such as dextrose monohydrate, for example), among others.

The term “sugar replacer” is taken to include bulking agents, high potency sweeteners, and protein-based sugar replacers. Bulking agents include but are not limited to monosaccharides or disaccharides having an energy content of ≤3 kcal/g; oligosaccharides; polysaccharides; sugar alcohols (including hydrogenation products of any monosaccharides, disaccharides, and of oligosaccharides/polysaccharides containing 3 or more monosaccharide units); dietary fiber (both insoluble and soluble); grains; cereals; resistant starches and flours containing resistant starches; novel bulking agents (such as powdered insects, algae biomass, upcycled plant material, seaweed, sand, calcium carbonate, and other minerals); and any combinations thereof.

Suitable oligosaccharides may be selected from the group comprising: galactooligosaccharides (GOS), fructooligosaccharides (FOS), isomaltoligosaccharides (IMO), xylooligosaccharides (XOS), raffinoses, cellotriose, xylotriose, kojitriose, human milk oligosaccharides, dextrins, xylodextrins, cellodextrins, partially hydrolysed hemicellulose (including hemicellodextrin), digestion resistant cyclodextrins, and combinations thereof, among others.

Suitable polysaccharides may be selected from the group comprising: inulins, arabinoxylans, pectins, polyglycitols, resistant starches, starch, celluloses, hemicelluloses, xylan, and combinations thereof, among others.

Suitable dietary fibers may be selected from the group comprising: polydextrose, maltodextrins, vegetable-derived fibers, plant-derived fibers, cellulose-derived fibers, hemicellulose based fibers, resistant dextrins, soluble corn/wheat fiber, inulin, arabinoxylan, polydextrose, oat fiber, wheat fiber, citrus fiber, pea fiber, micro-crystalline cellulose, cocoa pod husk fiber, maple fiber, pecan shell fiber, brewers spent grain powder, psyllium husk fiber, beta glucan, and combinations thereof, among others.

Suitable starches and/or flours containing resistant starches may be selected from the group comprising: natural high amylose corn/wheat/barley/rice/potato starch (RS2); high amylose corn/wheat/rice flour (RS2); modified starches from various sources (RS4); brans such as corn, oat, rice, wheat and barley bran; and combinations thereof, among others.

The sweetener may be an artificial sweetener and/or natural sweetener.

Artificial sweeteners may be selected from the group comprising: acesulfame K, advantame, alitame, aspartame, aspartame-acesulfame salt, cyclomates, glucin, neohespiridin dihydrochalcone, neotame, saccharin, sucralose, rebaudioside A, rebaudioside D, rebaudioside M and combinations thereof, among others

Natural sweeteners may be selected from the group comprising: glycyrrhizin, monatin, osladine, stevia, steviol glycosides, monk fruit, mogrosides, and combinations thereof, among others.

The product may comprise at least one emulsifier independently selected from the group comprising: lecithin derived from soya bean, safflower, corn etc., fractionated lecithins enriched with either phosphatidyl choline, phosphatidyl ethanolamine, phosphatidyl inositol; emulsifiers derived from oats, mono- and diglycerides and their tartaric esters, monosodium phosphate derivatives of mono- and diglycerides of edible fats and oils, sorbitan monostearate, polyoxymethylene sorbitan monostearate, hydroxylated lecithin, synthetic phospholipids such as ammonium phosphatides, poly glycerol polyricinoleate (PGPR), lactylated fatty acid esters of glycerol and propylene glycol, poly glycerol esters of fatty acids, citric acid esters of fatty acids, propylene glycol mono- and diesters of fats and fatty acids, and combinations thereof, among others. In certain embodiments, the product may comprise at least one emulsifier selected from: soya lecithin, and synthetic phospholipids such as ammonium phosphatides or polyglycerol polyricinoleate (PGPR).

The addition of at least one emulsifier to the product allows for easier modification of and better control over the rheology of the chocolate product. The emulsifier may act as a rheology modifier.

The flavors may be those traditionally associated with chocolate, such as vanilla, fruit flavorings, mint flavorings, fruit concentrates, spices, hazelnut paste, orange flavor, and the like, or flavors not traditionally associated with chocolate.

The one or more further ingredients may be present in a total amount of at least 5 g per 100 g of the chocolate product.

The one or more further ingredients may be present in a total amount of at least 5.5 g, 6.0 g, 6.5 g, 7.0 g, 7.5 g, 8.0 g, 8.5 g, 9.0 g, 9.5 g, 10.0 g, 10.5 g, 11.0 g, 11.5 g, 12.0 g, 12.5 g, 13.0 g, 13.5 g, 14.0 g, 14.5 g, 15.0 g per 100 g of the chocolate product.

The one or more further ingredients may be present in a total amount of no more than 17.4 g, 17.0 g, 16.5 g, 16.0 g, 15.5 g, 14.5 g, 14.0 g, 13.5 g, 13.0 g, 12.5 g, 12.0 g, 11.5 g, 11.0 g, 10.5 g, 10.0 g, 9.5 g, 9.0 g, 8.5 g, 8.0 g, 7.5 g, 7.0 g, 6.5 g, 6.0 g per 100 g of the chocolate product.

The one or more further ingredients may be present in an amount of from 5-17.4 g, 5-17.0 g, 5-16.5 g, 5-16.0 g, 5-15.5 g, 5-14.5 g, 5-14.0 g, 5-13.5 g, 5-13.0 g, 5-12.5 g, 5-12.0 g, 5-11.5 g, 5-11.0 g, 5-10.5 g, 5-10.0 g, 5-9.5 g, 5-9.0 g, 5-8.5 g, 5-8.0 g, 5-7.5 g, 5-7.0 g, 5-6.5 g, 5-6.0 g, 5.5 g-17.4 g, 6.0 g-17.4 g, 6.5 g-17.4 g, 7.0 g-17.4 g, 7.5 g-17.4 g, 8.0 g-17.4 g, 8.5 g-17.4 g, 9.0 g-17.4 g, 9.5 g-17.4 g, 10.0 g-17.4 g, 10.5 g-17.4 g, 11.0 g-17.4 g, 11.5 g-17.4 g, 12.0 g-17.4 g, 12.5 g-17.4 g, 13.0 g-17.4 g, 13.5 g-17.4 g, 14.0 g-17.4 g, 14.5 g-17.4 g, 15.0 g-17.4 g, 5.5-17.4 g, 6.0-17.0 g, 6.5-16.5 g, 7.0-16.0 g, 7.5-15.5 g, 8.0-15.0 g, 8.5-14.5 g, 9.0-14.0 g, 9.5-13.5 g, or from 10.0-13.0 g per 100 g of the chocolate product.

In some embodiments, the chocolate product may be temperature-resistant or heat resistant.

In such an embodiment, the chocolate product may comprise one or more hydrated salts, hydrated sugars and hydrated sugar alcohols.

Hydrated salts may be selected from the group comprising hydrates of alkali metal salts and hydrates of alkaline earth metal salts, such as sodium carbonate decahydrate and magnesium carbonate pentahydrate.

Hydrated sugars may be selected from the group comprising hydrated monosaccharides, hydrated disaccharides and hydrated polysaccharides. Monosaccharides include, for example, dextrose (glucose), fructose (levulose), galactose, xylose and ribose, disaccharides include, for example, saccharose (sucrose) and lactose, and polysaccharides include, for example, starch, glycogen and cellulose. An exemplary and referred hydrated monosaccharide is dextrose monohydrate, and an exemplary and preferred hydrated disaccharide is lactose monohydrate.

The water content of the chocolate product may be greater than 1.1 wt. % by weight of the chocolate product. In some embodiments, the total water content may be greater than 1.15 wt. %, 1.2 wt. %, 1.25 wt. %, 1.3 wt. %, 1.35 wt. % or greater than 1.4 wt. % by weight of the chocolate product. In some embodiments, the water content may be less than 2.5 wt. %, 2.4 wt. %, 2.3 wt. %, 2.2 wt. %, 2.1 wt. % or less than 2.0 wt. % by weight of the chocolate product. When the water content is as defined above, the composition results in chocolate with improved heat-resistance and also good taste and mouthfeel.

The chocolate product may comprise a polyol gel product.

The polyol gel may be formed by gelation of a polyol or a polyol/water mixture with a gelling agent. The gelling agents may be selected from the group comprising gelatin, agarose, pectin, xanthan gum, agar, kappa-carrageenan, sodium alginate and iota-carrageenan.

The polyol which is used for gelation is preferably a liquid and may be a straight or branched chain hydrocarbon based compound containing at least two hydroxyl groups on the carbon skeleton. For example, the polyol may be a dihydric alcohol, a trihydric alcohol such as glycerol, mannitol, sorbitol, propylene glycol or corn syrup or any combination thereof.

The addition of a polyol gel to the chocolate product may improve the heat resistance of the product.

In some embodiments, the chocolate product may have reduced rancidity and/or be more resistant to oxidation.

In such an embodiment, the chocolate product may comprise one or more ingredients selected from the group comprising an antioxidant and a preservative.

Suitable antioxidants and/or preservatives may be selected from the group consisting of benzoic acid alkali metal salts (e.g., sodium benzoate), sorbic acid alkali metal salts (e.g., potassium sorbate), ascorbic acid (Vitamin C), citric acid, calcium propionate, sodium erythorbate, sodium nitrite, calcium sorbate, butylated hydroxyanisole (BHA), butylated hydroxytoluene (BHT), ethylenediaminetetraacetic acid (EDTA), tocopherols (Vitamin E), straight chain polyphosphates, or a combination thereof.

In some embodiments, the chocolate product may comprise a vitamin E compound.

The vitamin E compound may be selected from the group comprising a tocopherol, a tocotrienol, or a combination thereof.

In some embodiments, the vitamin E compound is a tocopherol. Tocopherols are naturally found in vegetable oils, nuts, seeds, and whole grains. Naturally produced forms of the tocopherol as well as synthetic forms can be used. The tocopherols occur in alpha, beta, gamma and delta forms.

In some embodiments, the tocopherol is selected from the group consisting of alpha-tocopherol, beta-tocopherol, gamma-tocopherol, delta-tocopherol, and combinations comprising at least one of the foregoing tocopherols.

In other embodiments, vitamin E compounds such as tocotrienols can also be used to modify, mask or reduce the unpleasant taste impression of a bitter-tasting substance when administered in the presence of at least one fat. Tocotrienols are naturally found in very low levels in select vegetable oils, palm fruit oil, wheat germ, barley, saw palmetto, and certain types of nuts and grains. Naturally produced forms of the tocotrienol as well as synthetic forms can be used.

Tocotrienols, like tocopherols, are members of the vitamin E family and are structurally similar to tocopherol. The tocotrienols, like the tocopherols, occur in alpha, beta, gamma and delta forms. The tocotrienols also have the same methyl structure at the ring, but differ from tocopherols by the presence of three double bonds in the hydrophobic side chain.

In some embodiments, the chocolate product may have reduced fat bloom and/or sugar bloom.

In such an embodiment, the chocolate product may comprise a sorbitan monoester.

The term “sorbitan monoester”, as used herein, refers to a sorbitan monoester selected from the group consisting of sorbitan monomyristate, sorbitan monopalmitate, sorbitan monostearate, sorbitan monoarachidate, and combinations thereof.

The sorbitan monoesters described herein are known to have some bloom retarding function when included in chocolate products.

Examples of other additives which may retard fat and/or sugar bloom in chocolate products may be selected from the group consisting of hydrogenated butter fat, butylated hydroxy anisole (BHA), glycerol, anhydrous glucose, amino acids such as alpha amino N-butyric acid, glycine, cysteine and glutamic acids, bile acids, cetyl alcohol, cholesterol, choline-HCL, citric acid monoglyceride, lactose, low HLB sucrose polyesters, maltrins, methionine, polymerized cocoa butter, phytic acid, polyglycerol fatty esters, propylene glycol fatty acid esters, and combinations thereof.

The chocolate product may comprise less than 25, 24.9, 24.8, 24.7, 24.6, 24.5, 24.4, 24.3, 24.2, 24.1, 24, 23.9, 23.8, 23.7, 23.6, 23.5, 23.4, 23.3, 23.2, 23.1, 23, 22.9, 22.8, 22.7, 22.6, 22.5, 22.4, 22.3, 22.2, 22.1, 22, 21.9, 21.8, 21.7, 21.6, 21.5, 21.4, 21.3, 21.2, 21.1, 21, 20.9, 20.8, 20.7, 20.6, 20.5, 20.4, 20.3, 20.2, 20.1, 20, 19.9, 19.8, 19.7, 19.6, 19.5, 19.4, 19.3, 19.2, 19.1, 19, 18.9, 18.8, 18.7, 18.6, 18.5, 18.4, 18.3, 18.2, 18.1, 18, 17.9, 17.8, 17.7, 17.6, 17.5, 17.4, 17.3, 17.2, 17.1, 17, 16.9, 16.8, 16.7, 16.6, 16.5, 16.4, 16.3, 16.2, 16.1, 16, 15.9, 15.8, 15.7, 15.6, 15.5, 15.4, 15.3, 15.2, 15.1, 15, 14.9, 14.8, 14.7, 14.6, 14.5, 14.4, 14.3, 14.2, 14.1, 14, 13.9, 13.8, 13.7, 13.6, 13.5, 13.4, 13.3, 13.2, 13.1, 13, 12.9, 12.8, 12.7, 12.6, 12.5, 12.4, 12.3, 12.2, 12.1, 12, 11.9, 11.8, 11.7, 11.6, 11.5, 11.4, 11.3, 11.2, 11.1, 11, 10.9, 10.8, 10.7, 10.6, 10.5, 10.4, 10.3, 10.2, 10.1, 10, 9.9, 9.8, 9.7, 9.6, 9.5, 9.4, 9.3, 9.2, 9.1, 9, 8.9, 8.8, 8.7, 8.6, 8.5, 8.4, 8.3, 8.2, 8.1, 8, 7.9, 7.8, 7.7, 7.6, 7.5, 7.4, 7.3, 7.2, 7.1, 7, 6.9, 6.8, 6.7, 6.6, 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % sugar, or 0 wt % sugar by weight of the chocolate product.

The chocolate product may comprise less than 25, 24.9, 24.8, 24.7, 24.6, 24.5, 24.4, 24.3, 24.2, 24.1, 24, 23.9, 23.8, 23.7, 23.6, 23.5, 23.4, 23.3, 23.2, 23.1, 23, 22.9, 22.8, 22.7, 22.6, 22.5, 22.4, 22.3, 22.2, 22.1, 22, 21.9, 21.8, 21.7, 21.6, 21.5, 21.4, 21.3, 21.2, 21.1, 21, 20.9, 20.8, 20.7, 20.6, 20.5, 20.4, 20.3, 20.2, 20.1, 20, 19.9, 19.8, 19.7, 19.6, 19.5, 19.4, 19.3, 19.2, 19.1, 19, 18.9, 18.8, 18.7, 18.6, 18.5, 18.4, 18.3, 18.2, 18.1, 18, 17.9, 17.8, 17.7, 17.6, 17.5, 17.4, 17.3, 17.2, 17.1, 17, 16.9, 16.8, 16.7, 16.6, 16.5, 16.4, 16.3, 16.2, 16.1, 16, 15.9, 15.8, 15.7, 15.6, 15.5, 15.4, 15.3, 15.2, 15.1, 15, 14.9, 14.8, 14.7, 14.6, 14.5, 14.4, 14.3, 14.2, 14.1, 14, 13.9, 13.8, 13.7, 13.6, 13.5, 13.4, 13.3, 13.2, 13.1, 13, 12.9, 12.8, 12.7, 12.6, 12.5, 12.4, 12.3, 12.2, 12.1, 12, 11.9, 11.8, 11.7, 11.6, 11.5, 11.4, 11.3, 11.2, 11.1, 11, 10.9, 10.8, 10.7, 10.6, 10.5, 10.4, 10.3, 10.2, 10.1, 10, 9.9, 9.8, 9.7, 9.6, 9.5, 9.4, 9.3, 9.2, 9.1, 9, 8.9, 8.8, 8.7, 8.6, 8.5, 8.4, 8.3, 8.2, 8.1, 8, 7.9, 7.8, 7.7, 7.6, 7.5, 7.4, 7.3, 7.2, 7.1, 7, 6.9, 6.8, 6.7, 6.6, 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % added sugar, or 0 wt % added sugar by weight of the chocolate product.

The term “added sugar” is used herein to refer to an additional amount of sugar that may be naturally present in one of the ingredients, and is added to the chocolate product during or after processing

The chocolate product may comprise less than 25, 24.9, 24.8, 24.7, 24.6, 24.5, 24.4, 24.3, 24.2, 24.1, 24, 23.9, 23.8, 23.7, 23.6, 23.5, 23.4, 23.3, 23.2, 23.1, 23, 22.9, 22.8, 22.7, 22.6, 22.5, 22.4, 22.3, 22.2, 22.1, 22, 21.9, 21.8, 21.7, 21.6, 21.5, 21.4, 21.3, 21.2, 21.1, 21, 20.9, 20.8, 20.7, 20.6, 20.5, 20.4, 20.3, 20.2, 20.1, 20, 19.9, 19.8, 19.7, 19.6, 19.5, 19.4, 19.3, 19.2, 19.1, 19, 18.9, 18.8, 18.7, 18.6, 18.5, 18.4, 18.3, 18.2, 18.1, 18, 17.9, 17.8, 17.7, 17.6, 17.5, 17.4, 17.3, 17.2, 17.1, 17, 16.9, 16.8, 16.7, 16.6, 16.5, 16.4, 16.3, 16.2, 16.1, 16, 15.9, 15.8, 15.7, 15.6, 15.5, 15.4, 15.3, 15.2, 15.1, 15, 14.9, 14.8, 14.7, 14.6, 14.5, 14.4, 14.3, 14.2, 14.1, 14, 13.9, 13.8, 13.7, 13.6, 13.5, 13.4, 13.3, 13.2, 13.1, 13, 12.9, 12.8, 12.7, 12.6, 12.5, 12.4, 12.3, 12.2, 12.1, 12, 11.9, 11.8, 11.7, 11.6, 11.5, 11.4, 11.3, 11.2, 11.1, 11, 10.9, 10.8, 10.7, 10.6, 10.5, 10.4, 10.3, 10.2, 10.1, 10, 9.9, 9.8, 9.7, 9.6, 9.5, 9.4, 9.3, 9.2, 9.1, 9, 8.9, 8.8, 8.7, 8.6, 8.5, 8.4, 8.3, 8.2, 8.1, 8, 7.9, 7.8, 7.7, 7.6, 7.5, 7.4, 7.3, 7.2, 7.1, 7, 6.9, 6.8, 6.7, 6.6, 6.5, 6.4, 6.3, 6.2, 6.1, 6, 5.9, 5.8, 5.7, 5.6, 5.5, 5.4, 5.3, 5.2, 5.1, 5, 4.9, 4.8, 4.7, 4.6, 4.5, 4.4, 4.3, 4.2, 4.1, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or less than or equal to 0.1 wt % saturated fat, or 0 wt % saturated fat by weight of the chocolate product.

In some embodiments the chocolate product is a solid or a paste at ambient pressure up to 25° C., or up to 26, 27, 28, 29, 30, 31, 32, 33, 34, 35, 36, 37, 38, 39 or up to at least 40° C.

Preferably, the chocolate product is a non-powder solid at ambient pressure up to 25° C., or up to 26, 27, 28, 29, 30, 31, 32, 33, 34, 35, 36, 37, 38, 39 or up to at least 40° C.

By “non-powder solid” powder and granules are excluded.

In some embodiments, the chocolate product is a solid molded chocolate product. The molded chocolate product may be in the form of a stick, a rod, a tablet, a block, a bar, or shapes such as eggs, animals, stars, Santa, cuboid, spheroid, sphere etc.

In some embodiments the chocolate product may be provided in a form and size intended to provide multiple servings. The multiple serving of the chocolate product may have a weight greater than 30 g, 40 g, 50 g, 60 g, 70 g, 80 g, 90 g, 100 g, 250 g or greater than 500 g. The multiple serving of the chocolate product may be one body. The body of chocolate product may have defined portions intended to be broken or torn off the body of the chocolate product to provide a serving of the product. A suitable form of the body of product may be a tablet, block, or bar. The term “tablet” is known in the art to refer to a substantially planar chocolate product with portions, for example squares, defined by grooves or other break lines or regions in the product.

The chocolate product may be in the form of a shell, sheet, or the like, for example.

In other embodiments, the inventive chocolate product is a chocolate coating, preferably a solid chocolate coating. The inventive chocolate product may coat an edible product or inedible product.

The edible product may be a chocolate product or a non-chocolate product.

The edible product may be selected from the group comprising a fruit, dried fruit, dried fruit piece, fruit pastes, a nut, a nut piece, vegetable, or dried vegetables.

The fruit, dried fruit or dried fruit piece may be selected from the group comprising a raisin, dried raisin, sultana, prune, current, strawberry, date, cranberry, plum, blueberries, apricot, or cherry.

The nut or nut piece may be selected from the group comprising almond, peanut, macadamia nut, hazelnut, coconut, pecan, palm nut, walnut, pistachio, cashew, Brazil nut, soy nut, chestnut or pine nut.

The edible product may be a farinaceous product, or a baked farinaceous product.

The edible product may be a baked product. The baked product may be selected from the group comprising cakes, doughnuts, wafers, pastries, or tarts.

The edible product may be a confectionery product. The confectionery product may be selected from the group comprising hard candy, jelly candy, chewy candy, toffee, fudge or marshmallow.

The inedible product may be a stick, such as a wooden lolly stick.

In a second aspect of the invention, there is provided a packaged chocolate product according to the first aspect of the present invention.

The chocolate product may be packaged in any suitable packaging material, which may in some embodiments be any one or more materials independently selected from the group comprising cardboard, paper, paperboard, flow-wrap plastics, metal foil, plastics foil and combinations and laminates thereof.

The packaged chocolate product may comprise the chocolate product of the first aspect of the invention. Statements of invention relating to the chocolate product of the first aspect of the invention may also be applied to the second aspect of the invention.

Suitable packaging for the chocolate product may be reclosable or not reclosable (or resealable or not resealable) as known to a person skilled in the art.

The packaged chocolate product may be provided in a form and size intended for a single serving.

A single serving may have a weight in the range of from 10 g to 200 g.

In some embodiments the packaged chocolate product may be provided in a form and size intended to provide multiple servings. The multiple serving of the chocolate product may have a weight greater than 30 g, 40 g, 50 g, 60 g, 70 g, 80 g, 90 g, 100 g, 250 g or greater than 500 g. The multiple serving of the chocolate product may comprise a single body. The single body of chocolate product may have defined portions intended to be broken or torn off the body of the chocolate product to provide a serving of the product. A suitable form of the one body of edible product may be a tablet, block, or bar.

In some embodiments, a multiple serving of the chocolate product may be provided as individual pieces. Suitably, the bite-size pieces may have a weight in the range of from 1 g to 30 g. The bite-size pieces may be individually wrapped. Alternatively, the bite-size pieces may not be individually wrapped. A plurality of bite-size pieces may be contained in a suitable container. The container may be reclosable and/or resealable.

In a third aspect of the present invention, there is provided a method of preparing the chocolate product of the first aspect of the invention, the method comprising the step of combining at least one cocoa ingredient, at least one dairy ingredient and at least one softening agent.

Statements of invention relating to the chocolate product of the first aspect of the invention may also be applied to the third aspect of the invention.

The method may comprise a step of molding or extruding the chocolate product to form a bar or block, after combining the ingredients. Preferably, the method may comprise molding the chocolate product to form a solid bar or block.

The method may include any one or more of size-reducing, refining, conching, tempering and pasting the chocolate product, or ingredients thereof, as is customary in the art of chocolate-making.

The method may further comprise packaging the chocolate product to produce the packaged chocolate product of the third aspect of the invention. Statements of invention above relating to the packaged chocolate product of the second aspect of the invention may also be applied to the third aspect of the invention.

The process may comprise one or more steps to improve temperature or heat resistance.

In such an embodiment, the method may include a step of thermo-curing the chocolate product. Thermo-curing can be effected by, e.g., maintaining the optionally tempered/molded and packaged chocolate mass at a temperature not exceeding 40° C., preferably at a temperature in the range of from 30 to 40° C., for, e.g., up to and including 6 weeks, preferably up to and including 4 weeks. It is advisable that packaged chocolate products are not weight-bearing during the thermo-curing step to better allow the heat resistance to develop and to prevent deformation of the product.

The process may comprise one or more steps to prevent fat and/or sugar bloom.

In such an embodiment, the method may comprise a step of tempering the chocolate product.

Tempering is the process of inducing satisfactory crystal nucleation of the liquid fat in chocolate so that the chocolate forms stable R crystals. Tempering is typically thermal, and involves melting the fat at approximately 43-50° C. and then slowly cooling with constant stirring to 26-29° C. to form nuclei for fat crystal growth. During this time the chocolate becomes more viscous and if not quickly processed further it will become too thick to process. It is then typically reheated to 31-32° C. (lower for milk chocolate, depending on the milk fat content) to melt unstable crystals and held at that temperature during production. Subsequent cooling then produces only stable fat crystals.

According to another aspect of the invention there is provided a method of providing a filled or coated edible product, in which an edible product is filled or coated with a chocolate product of the first aspect of the invention.

In some embodiments, the inventive chocolate product is applied to an edible product as a coating. Alternatively, the inventive chocolate product may be applied to an inedible product.

In some embodiments, the chocolate product is applied as a molten coating and solidified. The edible product may be a chocolate product or non-chocolate product. Edible products include but are not limited to those listed for the first aspect of the invention. The inedible product may include but are not limited to those listed for the first aspect of the invention.

Any suitable method of coating known to those skilled in the art may be employed. Such a method may provide a layer of the inventive chocolate product on a surface of the edible product. The surface may comprise an outer surface of the edible product. The method may comprise coating a layer of the inventive chocolate product on at least 50% of the outer surface area of the edible product, or on at least 60, 70, 80, 90%, or on substantially 100% of the outer surface area of the edible product. In some embodiments, the method comprises enrobing the edible product with the inventive chocolate product. The method may comprise passing the edible product through a curtain or stream of the inventive chocolate product. The curtain or stream may be formed by molten inventive chocolate product falling from an elevated position relative to the edible product. The molten inventive chocolate product may fall from an elevated trough or like device fed from a suitable container.

In some embodiments, the method comprises dipping the edible product into the molten inventive chocolate product. Suitable methods of dipping include hand-dipping and dipping the edible product using suitable machinery known in the art.

In some embodiments, the method comprises pan coating the edible product with the inventive chocolate product. Pan coating is known to those skilled in the art and makes use of rotating drums to coat the edible product with a chocolate coating. The pan coating method may include but is not limited to one or more of: spray pan coating, ladling, and drip-feeding.

In some embodiments, the method comprises providing a filled chocolate product comprising the inventive chocolate product as a chocolate shell or layer surrounding a filling of edible product. The method may comprise the steps of: providing a shell of the chocolate product and providing a filling, depositing the filling into the chocolate shell, and optionally sealing the chocolate shell. Chocolate shells any suitable shape may be provided, such as eggs, animals, stars, Santa, etc. Suitable fillings include but are not limited to the fillings listed for the first aspect of the invention.

In some embodiments, the chocolate product shell is provided as two complementary fitting sections. The complementary fitting sections of the shell may be attachable to each other to provide a sealed chocolate shell defining an internal cavity capable of containing the filling. At least one or both complementary fitting sections of the shell may define their own cavity into which a filling may be independently deposited before attaching the sections to each other to provide the sealed chocolate shell. The filling in each section may be the same or different. In some embodiments, only one of the two complementary fitting sections of the shell defines its own cavity, and the other section is in the form of a flat or substantially flat chocolate backing.

In some embodiments, the step of providing the chocolate shell comprises forming a first section of the shell in a mold cavity. In such embodiments, the first section defines a cavity in the shape of the mold cavity and into which the filling may be deposited. Molds may preferably be selected to match the shapes and/or sizes of the chocolate product as detailed in the first aspect of the invention. The step of sealing the chocolate shell may comprise applying a chocolate backing over the first section of the shell and over the filling contained in the first section to seal the shell with the filling enclosed within.

The step of sealing the chocolate shell by attaching two complementary fitting sections of the shell to each other may employ any suitable method known to those skilled in the art. Examples of suitable methods include but are not limited to gluing the sections to each other using an edible glue or applying heat to the points of contact of the two sections to facilitate sealing.

In some embodiments, the method comprises filling an edible product with the prepared inventive chocolate product. Any suitable method of filling known to those skilled in the art may be employed. The edible product may include but is not limited to the edible products described in the first aspect of the invention, especially confectionery and farinaceous or baked products. The edible product may be provided in the form of one or more shells, as described hereinabove for embodiments in which the chocolate product is provided as one or more shells. In some embodiments, the chocolate product, in molten or paste form, may be extruded, injected, or otherwise deposited into a cavity formed in the edible product, and optionally solidified thereafter.

The filled or coated edible product may be packaged, as described hereinabove for other aspects of the invention.

### DETAILED DESCRIPTION OF THE INVENTION

In order that the invention may be more clearly understood one or more embodiments thereof will now be described, by way of example only.

### Inventive Chocolate Products

The following chocolate products of the invention were prepared. The chocolate products were molded using standard chocolate making techniques.

The chocolate products were able to provide a sweet taste and indulgent mouthfeel, whilst providing a number of nutritious food groups in a recommended serving size.

### Example 1

A chocolate product according to the present invention was produced containing the ingredients shown in Table 1 below.

The chocolate product comprised a dairy ingredient in at least 35.4 g per 100 g of the chocolate product and a cocoa ingredient present in at least 47.2 g per 100 g.

TABLE 1
Ingredient composition for Example 1.

| | Chocolate |
|---|---|
| | product |
| Ingredient | /100 g |
| Cocoa mass | 47.2 |
| Low fat milk powder | 35.4 |
| Sweetener | 0.5 |
| Emulsifier | 0.5 |
| Flavor | 0.5 |
| Other ingredients | 15.9 |
| Total | 100 |

### Example 2

A chocolate product according to the present invention was produced containing the ingredients shown in Table 2 below.

The chocolate product comprised a dairy ingredient present in at least 35.4 g per 100 g of the chocolate product and a total amount of softening ingredient and cocoa ingredient present of at least 47.2 g per 100 g.

TABLE 2
Ingredient composition for Example 2.

| | Chocolate |
|---|---|
| | product |
| Ingredient | /100 g |
| Cocoa mass | 23.6 |
| Palm butter | 23.6 |
| Low fat milk powder | 35.4 |
| Sweetener | 0.5 |
| Emulsifier | 0.5 |
| Flavor | 0.5 |
| Other ingredients | 15.9 |
| Total | 100 |

### Example 3

A chocolate product according to the present invention was produced containing the ingredients shown in Table 3 below.

The chocolate product comprised a dairy ingredient present in at least 35.4 g per 100 g of the chocolate product and a total amount of softening ingredient and cocoa ingredient present of at least 47.2 g per 100 g.

TABLE 3
Ingredient composition for Example 3.

| | Chocolate |
|---|---|
| | product |
| Ingredient | /100 g |
| Cocoa mass | 23.6 |
| Hazelnut paste | 23.6 |
| Low fat milk powder | 35.4 |
| Sweetener | 0.5 |
| Emulsifier | 0.5 |
| Flavor | 0.5 |
| Other ingredients | 15.9 |
| Total | 100 |

### Example 4

A coated edible product according to the present invention was produced comprising a raisin coated with a chocolate product according to Example 1.

The coated edible product was produced by applying the chocolate product of Example 1 to a raisin as a molten coating and solidifying.

The coating comprised the same ingredient profile as detailed in Example 1.

The one or more embodiments are described above by way of example only. Many variations are possible.

1: A chocolate product comprising at least one cocoa ingredient, at least one dairy ingredient and at least one softening ingredient, wherein at least one of the following conditions is satisfied:
a) the dairy ingredient is present in at least 35.4 g per 100 g of the chocolate product and the cocoa ingredient is present in at least 47.2 g per 100 g of the chocolate product and preferably the total combined amount of the dairy ingredient and cocoa ingredient is no more than 95 g per 100 g of the chocolate product; or
b) the dairy ingredient is present in at least 35.4 g per 100 g of the chocolate product and the total combined amount of cocoa ingredient and softening ingredient is at least 47.2 g per 100 g of the chocolate product, wherein the softening ingredient is derived from nuts and/or seeds and wherein preferably the total combined amount of the dairy ingredient, softening ingredient and cocoa ingredient is no more than 95 g per 100 g of the chocolate product.

2: A chocolate product according to claim 1, wherein the dairy ingredient is selected from the group consisting of low fat milk powder, skimmed milk powder, whole milk powder and whey powder.

3: A chocolate product according to claim 1, wherein the softening ingredient is a paste, oil or butter.

4: A chocolate product according to claim 1, wherein the softening ingredient is derived from nuts and/or seeds.

5: A chocolate product according to claim 4, wherein the ingredient derived from nuts and/or seeds is selected from the group consisting of almonds, peanuts, macadamia nuts, hazelnuts, coconut, pecans, palm, walnuts, pistachios, cashews, Brazil nuts, sunflower seeds, poppy seeds, pumpkin seeds, chia seeds, canola seeds coffee beans and cocoa beans, or any combination thereof.

6: A chocolate product according to claim 1, wherein the softening ingredient is a butter derived from nuts and/or seeds selected from the group consisting of cocoa beans, peanuts, hazelnuts, walnuts, palm nuts, canola seeds and sunflower seeds.

7: A chocolate product according to claim 1 wherein the product further comprises one or more ingredients selected from the group consisting of a sugar, fat, oil, emulsifier, thickener, preservative, water, colors, flavors, sweetener, salt and sugar replacer.

8: A chocolate product according to claim 7, wherein the emulsifier is selected from the group comprising: lecithin derived from soya bean, safflower, corn etc., fractionated lecithins enriched with either phosphatidyl choline, phosphatidyl ethanolamine, phosphatidyl inositol; emulsifiers derived from oats, mono- and diglycerides and their tartaric esters, monosodium phosphate derivatives of mono- and diglycerides of edible fats and oils, sorbitan monostearate, polyoxymethylene sorbitan monostearate, hydroxylated lecithin, synthetic phospholipids such as ammonium phosphatides, poly glycerol polyricinoleate (PGPR), lactylated fatty acid esters of glycerol and propylene glycol, poly glycerol esters of fatty acids, citric acid esters of fatty acids, propylene glycol mono- and diesters of fats and fatty acids, and combinations thereof.

9: A chocolate product according to claim 7, wherein the sweetener is selected from the group comprising: acesulfame K, advantame, alitame, aspartame, aspartame-acesulfame salt, cyclomates, glucin, neohespiridin dihydrochalcone, neotame, saccharin, sucralose, rebaudioside A, rebaudioside D, rebaudioside M, glycyrrhizin, monatin, osladine, stevia, steviol glycosides, monk fruit, mogrosides, and combinations thereof.

10: A chocolate product according to claim 7, wherein the sugar replacer is a bulking agent and wherein the bulking agent is selected from the group consisting of monosaccharides or disaccharides having an energy content of ≤3 kcal/g; oligosaccharides; polysaccharides; sugar alcohols (including hydrogenation products of any monosaccharides, disaccharides, and of oligosaccharides/polysaccharides containing 3 or more monosaccharide units); dietary fiber (both insoluble and soluble); grains; cereals; resistant starches and flours containing resistant starches; novel bulking agents (such as powdered insects, algae biomass, upcycled plant material, seaweed, sand, calcium carbonate, salt, and other minerals); and any combinations thereof.

11: A chocolate product according to claim 7, wherein the flavor is selected from the group consisting of vanilla, fruit flavorings, mint flavorings, fruit concentrates, spices, hazelnut paste, orange flavor, and combinations thereof.

12: A chocolate product according to claim 1, wherein the chocolate product is a coating of an edible product.

13: A chocolate product according to claim 12, wherein the edible product is selected from the group comprising a fruit, dried fruit, dried fruit piece, fruit paste, a nut, a nut piece, vegetable, or dried vegetable.

14: A packaged chocolate product according to claim 1.

15: A method of preparing a chocolate product according to claim 1, the method comprising the step of combining at least one cocoa ingredient, dairy ingredient, and at least one softening agent.

16: A method of providing a filled or coated edible product, in which an edible product is filled or coated with a chocolate product according to claim 1.
